(19) United States
(12) Patent Application Publication
(10) Pub. No.: US 2011/0297785 A1
(43) Pub. Date: Dec. 8, 2011

(54) AIRFRAME POSITION ADJUSTING STRUCTURE

(76) Inventor: Eiji Itakura, Shizuoka (JP)

(21) Appl. No.: 13/201,224

(22) PCT Filed: Feb. 23, 2009
(86) PCT No.: PCT/JP2009/053194

§ 371 Date: Aug. 12, 2011

(51) Int. Cl. B64C 25/56; B64C 1/00

(52) U.S. Cl. 244/100 A; 244/117 R; 244/119

(57) ABSTRACT

Provided is an airframe position adjusting structure capable of adjusting the position of an airframe (A) inclined in the left-and-right direction. In the airframe position adjusting structure (1), the position adjusting unit (10) is configured such that a component force (FV), in the up-and-down direction of the airframe, of a ground reaction force (F) to be received from the ground (G) may be greater as the rolling angle (φ) when the airframe (A) touches down becomes greater. The component force (FV), in the up-and-down direction of the airframe, of the ground reaction force (F) acts as a force to return the airframe (A) to a horizontal position so that the position of the airframe (A) inclined in the left-and-right direction can be adjusted when the airframe (A) touches down.

### CROSS-REFERENCE TO RELATED APPLICATIONS

This application is a national phase application of International Application No. PCT/JP2009/053194, filed Feb. 23, 2009, the contents of which are incorporated herein by reference.

### TECHNICAL FIELD

The present invention relates to an airframe position adjusting structure of an aircraft.

### BACKGROUND ART

Conventionally, in aircraft, there is, for example, an apparatus described in Japanese Unexamined Patent Application Publication No. 2006-232075, as an apparatus for protecting passengers from the impact of landing. This apparatus includes impact-absorbing means made of honeycomb structures which are laminated in multiple levels in an up-and-down direction, under seats.

In this apparatus, if a predetermined load in the up-and-down direction is applied to seats when an aircraft lands, the impact-absorbing means moves down along with the seats, and the honeycomb structures of the impact-absorbing means are deformed under the impact energy from the bottom of the airframe. In this way, the impact energy is absorbed by deforming the impact-absorbing means.

### CITATION LIST

### Patent Literature

Japanese Unexamined Patent Application Publication No. 2006-232075

### SUMMARY OF INVENTION

### Technical Problem

In the apparatus described in Japanese Unexamined Patent Application Publication No. 2006-232075, the load of the airframe in the up-and-down direction is premised as the load applied to the impact-absorbing means. However, in actual landing, for example, a case where the airframe touches down in the state of being inclined in the left-and-right direction is also supposed. When the airframe touches down supposing such a case, a technique in which the position of the airframe inclined in the left-and-right direction can be adjusted is in demand.

Thus, the invention has been made in order to solve such a technical problem, and the object thereof is to provide an airframe position adjusting structure capable of adjusting the position of an airframe inclined in the left-and-right direction when the airframe touches down.

### Solution to Problem

That is, an airframe position adjusting structure related to the invention includes a position adjusting unit which adjusts the position of an airframe using a ground reaction force that the airframe receives when the airframe touches down. The position adjusting unit is configured such that, as the rolling angle when the airframe touches down becomes greater, a component force in the up-and-down direction of the airframe, of the ground reaction force becomes greater.

In the airframe position adjusting structure related to the invention, the position adjusting unit is configured such that, as the rolling angle when the airframe touches down becomes greater, the component force, in the up-and-down direction of the airframe, of the ground reaction force received from the ground becomes greater. Here, the rolling angle is the angle of rotation based on the longitudinal axis of the airframe, that is, the inclination angle of the airframe in the left-and-right direction.

Therefore, in the airframe position adjusting structure related to the invention, as the inclination of the airframe in the left-and-right direction becomes greater, the component force, in the up-and-down direction of the airframe, of the ground reaction force that the position adjusting unit receives from the ground becomes greater. The component force, in the up-and-down direction of the airframe, of this ground reaction force acts as a force to return the airframe horizontally. Accordingly, according to the invention, when the airframe touches down, the position of the airframe inclined in the left-and-right direction can be adjusted.

Additionally, in the airframe position adjusting structure related to the invention, preferably, the position adjusting unit is provided within a predetermined range from the bottom of the fuselage of the airframe to the lateral side, and the strength of the position adjusting unit is made greater as the distance from the bottom becomes greater.

It is considered that, when the airframe touches down, as the rolling angle becomes greater, the portion where the fuselage of the airframe touches the ground becomes a portion which is separated from the bottom. In this invention, the strength of the position adjusting unit is made greater as the distance from the bottom of the fuselage becomes greater.

Since the position adjusting unit is not easily deformed as the strength of the touchdown portion is greater in this way, as the rolling angle becomes greater, the ground reaction force that the position adjusting unit receives from the ground is not absorbed, and a large ground reaction force is generated. Hence, as the rolling angle when the airframe touches down becomes greater, the action of a force to return the airframe horizontally becomes greater, so that the position of the airframe can be effectively adjusted.

Additionally, in the airframe position adjusting structure related to the invention, preferably, the position adjusting unit is composed of members with greater strength as the distance from the bottom becomes greater.

According to this invention, the position adjusting unit is composed of members with greater strength as the distance from the bottom of the fuselage becomes greater. Therefore, a greater strength can be obtained as the distance from the bottom becomes greater. Hence, the airframe position adjusting function as described above is favorably realized.

Additionally, in the airframe position adjusting structure according to the invention, preferably, the position adjusting unit has protruding portions which protrude toward the surface side of the fuselage of the airframe and extend toward the lateral side from the bottom of the fuselage, and the protruding portions extend in a direction in which the angle formed with respect to a front-and-back direction line of the fuselage becomes greater as the distance from the bottom becomes greater.

It is considered that, when the airframe touches down, as the rolling angle becomes greater, the portion where the fuselage of the airframe touches the ground becomes a portion which is separated from the bottom. In this invention, the protruding portions which extend toward the surface side of the fuselage extend in a direction in which the angle formed with respect to the front-and-back direction line of the fuselage becomes greater as the distance from the bottom of the fuselage becomes greater.

When the ground reaction force from the ground is applied to the protruding portions extending in a direction in which the angle formed with respect to the front-and-back direction line of the fuselage is large, the component force, in the up-and-down direction of the fuselage, of the ground reaction force becomes large as the protruding portions act as resistance. Hence, as the rolling angle when the airframe touches down becomes greater, a force to return the airframe horizontally acts greatly, so that the position of the airframe can be effectively adjusted.

Additionally, in the airframe position adjusting structure related to the invention, preferably, the position adjusting unit has air bags capable of being deployed when the airframe touches down, on the undersurfaces of right and left main wings of the airframe.

According to this invention, when an airframe touches down, the air bags that the position adjusting unit has on the main wing undersurface are deployed. Since the air bags are strongly pushed against the ground as the rolling angle of the airframe becomes greater, the component force in the up-and-down direction of the airframe of the ground reaction force that the position adjusting unit receives from the ground becomes greater by a corresponding amount. Hence, the position of the airframe can be adjusted while mitigating the impact to the airframe.

Additionally, in the airframe position adjusting structure related to the invention, the air bags are preferably provided nearer the fuselage than the central portions of the main wings in the longitudinal direction.

According to this invention, the air bags are provided nearer the fuselage than the central portions of the main wings in the longitudinal direction. Therefore, even in a case where the main wings of the airframe touch down and the tips thereof drop out, the air bags remain on the fuselage side, without dropping out. Hence, the airframe position adjusting function as described above is favorably realized.

### Advantageous Effects of Invention

According to the airframe position adjusting structure related to the invention, when the airframe touches down, the position of the airframe inclined in the left-and-right direction can be adjusted.

### BRIEF DESCRIPTION OF DRAWINGS

FIG. 1 is a perspective view showing an airframe position adjusting structure related to a first embodiment.

FIG. 2 is a cross-sectional view taken along the line II-II of the airframe position adjusting structure of FIG. 1.

FIG. 3 is a view showing a state where the rolling angle when the airframe touches down is large, in the first embodiment.

FIG. 4 is a view when a nose of the airframe is seen from the direction D of FIG. 3.

FIG. 5 is a view showing a state where the rolling angle when the airframe touches down is small, in the first embodiment.

FIG. 6 is a view when a nose of the airframe is seen from the direction D of FIG. 5.

FIG. 7 is a view showing the relationship between the rolling angle and a component force in the up-and-down direction of the airframe, when the airframe touches down.

FIG. 8A is a perspective view showing the airframe position adjusting structure related to a second embodiment, and FIG. 8B is a cross-sectional view taken along the line B-B.

FIG. 9 is a view showing the relationship between the distance from the bottom and a direction in which a protruding portion extends, in the airframe position adjusting structure of FIG. 8.

FIG. 10 is a view of the second embodiment corresponding to FIG. 4.

FIG. 11 is a view of the second embodiment corresponding to FIG. 6.

FIG. 12 is a front view of an airframe position adjusting structure related to a third embodiment.

FIG. 13 is a view showing a state when the airframe touches down in the third embodiment.

### REFERENCE SIGNS LIST

1, 20, 30: AIRFRAME POSITION ADJUSTING STRUCTURE,
2: FUSELAGE
3: NOSE
4: MAIN WING
10, 21, 31: POSITION ADJUSTING UNIT
11 to 14: MEMBER
22: PROTRUDING PORTION
32: AIR BAG
A: AIRFRAME
C: CENTRAL PORTION
F: GROUND REACTION FORCE
FV: COMPONENT FORCE IN UP-AND-DOWN DIRECTION OF AIRFRAME
L: FRONT-AND-BACK DIRECTION LINE
θ: ANGLE FORMED WITH RESPECT TO FRONT-AND-BACK DIRECTION LINE
φ: ROLLING ANGLE

### DESCRIPTION OF EMBODIMENTS

Hereinafter, preferred embodiments of the invention will be described with reference to the accompanying drawings. In addition, in the description of the drawings, the same reference numerals will be given to the same elements, and repeated description will be omitted.

### First Embodiment

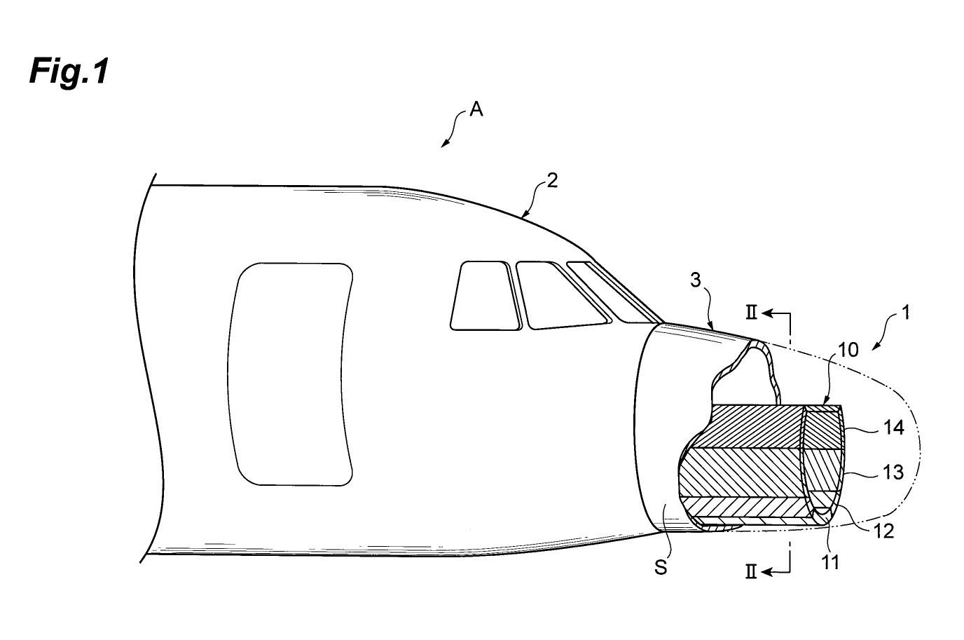

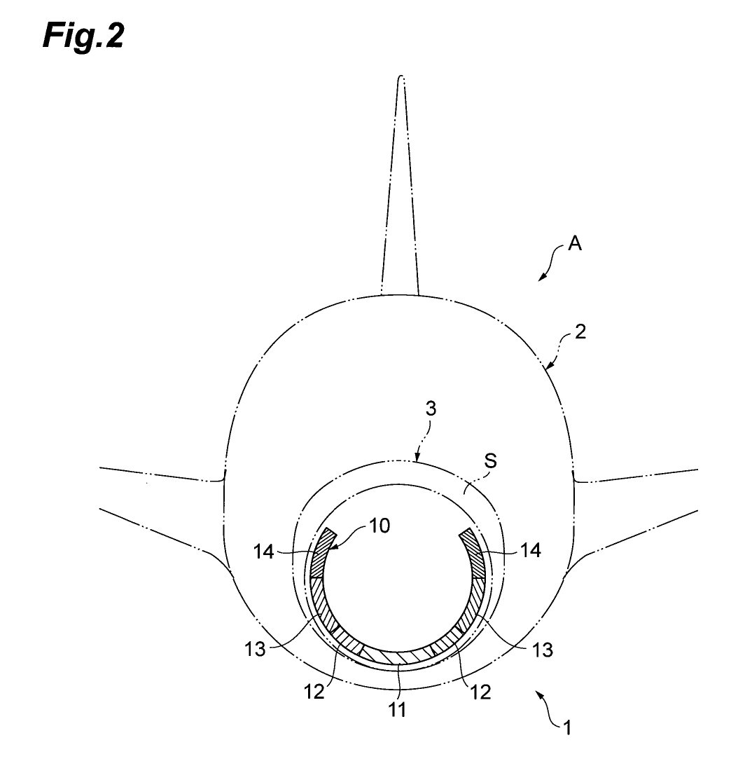

FIG. 1 is a perspective view showing the airframe position adjusting structure related to a first embodiment, and FIG. 2 is a cross-sectional view taken along the line II-II. An airframe position adjusting structure 1 of an aircraft shown in FIGS. 1 and 2 is provided at the fuselage 2 of an airframe A to adjust the position of the airframe A inclined in the left-and-right direction when the airframe A touches down. The airframe position adjusting structure 1 includes a position adjusting unit 10 for adjusting the position of the airframe A. The position adjusting unit 10 has the function of adjusting the position of the airframe A, using a ground reaction force that the airframe A receives when the airframe A touches down, and the details thereof will be described below.

The position adjusting unit 10 is provided within a predetermined range from the bottom of a nose 3 to the lateral side. The position adjusting unit 10 is formed such that several members 11 to 14 of different materials are stacked. As shown in FIG. 2, the position adjusting unit 10 has a bottom member 11, a first lateral member 12, a second lateral member 13, and the third lateral member 14 from the bottom of the nose 3 to the lateral side. These members are joined together to form the inner peripheral surface of the nose 3.

Here, the strength of the position adjusting unit 10 is made greater as the distance from the bottom of the nose 3 becomes greater. Here, the position adjusting unit 10 is composed of members with greater strength as the distance from the bottom of the nose 3 becomes greater. More specifically, strength is made greater in order from the bottom member 11, the first lateral member 12, the second lateral member 13, and the third lateral member 14.

As the bottom member 11, for example, members with relatively low strength, such as foaming aluminum, are used. As the first lateral member 12, for example, an aluminum honeycomb or the like is used. As the second lateral member 13, for example, members with relatively high strength, such as a CFRP (carbon fiber reinforced plastics) honeycomb, are used. As the third lateral member 14, for example, high-strength members, such as rigid body CFRP, are used.

In this way, according to the position adjusting unit 10 which forms the inner peripheral surface of the nose 3, even in a case where an engine is provided at the nose 3, for example, in a small propeller plane, the position adjusting unit 10 does not hinder installation of the engine. On the other hand, in a case where an engine is not installed at the nose 3 in a large passenger airplane or the like, a shape obtained by stacking plate-shaped members extending in the width direction of the nose 3 sequentially from the bottom, may be adopted instead of the shape as shown in FIG. 2. In addition, a thin plate-shaped skin S which covers the position adjusting unit 10 is appropriately provided on the outer surface of the nose 3.

Additionally, an energy absorption structure (in the following description, referred to as “EA (Energy Absorption) structure”) (not shown) in the longitudinal direction of the fuselage 2 is provided at the bottom of the fuselage 2 of the airframe A. When the fuselage 2 of the airframe A has touched down, this EA structure absorbs the impact energy caused by the touchdown while receiving a dynamic frictional force from the ground, and stops the airframe A safely.

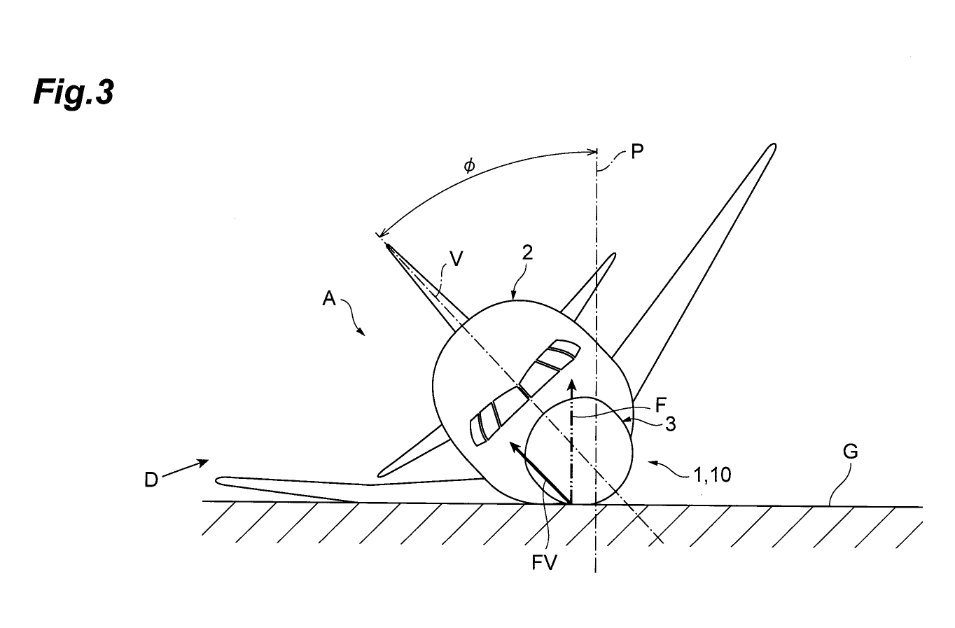

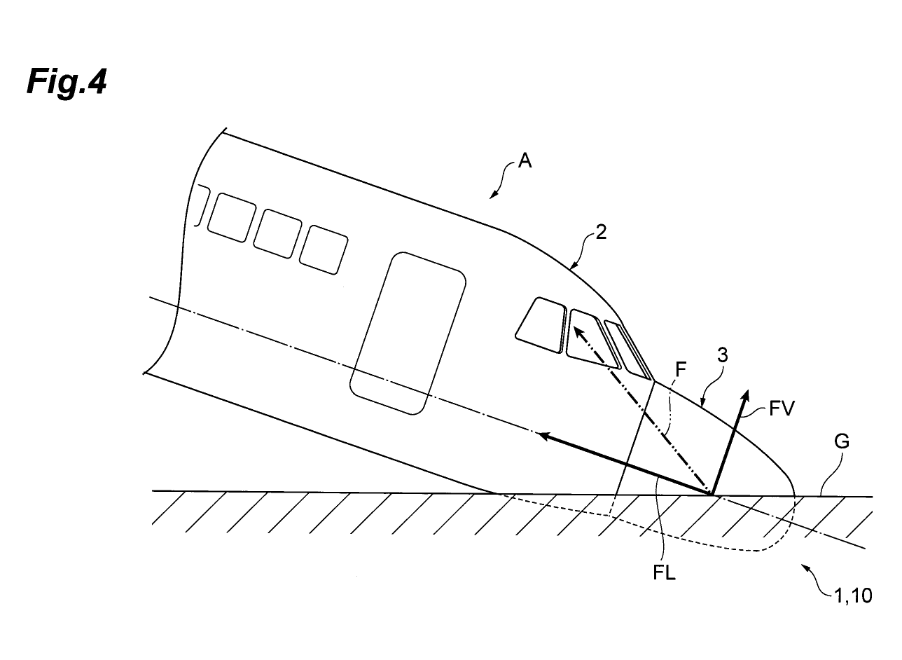

The functions of the airframe position adjusting structure 1 having the above configuration will be described. In the following description, a state where the airframe A touches down from the nose 3 at a predetermined speed, in a state where the airframe is inclined in a left-and-right direction at a predetermined rolling angle and is inclined forward is supposed. FIG. 3 is a view showing a state when the airframe A including the airframe position adjusting structure 1 touches down. In FIG. 3, the rolling angle φ of the airframe A is shown as an angle formed between a perpendicular line P and a vertical line V of the airframe A (fuselage 2). Additionally, FIG. 4 is a view as the nose of the airframe is seen from the direction D of FIG. 3.

In a case where the airframe A has touched down in a forwardly inclined state, as shown in FIG. 4, it is considered that the nose 3 of the airframe A touches down first. Here, in a case where the airframe A has touched down at a large rolling angle φ as shown in FIG. 3, members (for example, the lateral members 13 and 14 shown in FIG. 2) on the side of the lateral face among the members which constitute the position adjusting unit 10 face the ground G side. Then, the position adjusting unit 10 receives the ground reaction force F from the ground G via the second lateral member 13 or the third lateral member 14. In addition, illustration of the members 11 to 14 which constitute the position adjusting unit 10 is omitted in FIG. 4.

Since the second lateral member 13 or the third lateral member 14 has a greater strength than the first lateral member 12 or the bottom member 11, the member is not easily deformed even when receiving the ground reaction force F, and the ground reaction force F is not easily absorbed. For this reason, as shown in FIGS. 3 and 4, a large ground reaction force F is produced. As a result, the component force FV in the up-and-down direction of the airframe becomes large. In addition, in FIGS. 3 and 4, the ground reaction force F is shown by an imaginary line, and the component force FV in the up-and-down direction of the airframe and a component force FL in the front-and-rear direction of the airframe which are component forces of the ground reaction force F are shown by solid lines. Additionally, illustration of the component force in the left-and-right direction of the airframe is omitted.

Since the component force FV in the up-and-down direction of the airframe acts as a force to return the nose 3, that is, the fuselage 2, to horizontal, the fuselage 2 receives the ground reaction force F (component force FL in the front-and-rear direction of the airframe of FIG. 4), and returns in the horizontal direction while slowing down. In this way, the position adjusting unit 10 has the function of adjusting the position of the airframe A, using the ground reaction force F that the airframe A receives when the airframe A touch down. Additionally, as the airframe A returns in the horizontal direction, the rolling angle φ becomes small, and members near the bottom among the members which constitute the position adjusting unit 10 touches down.

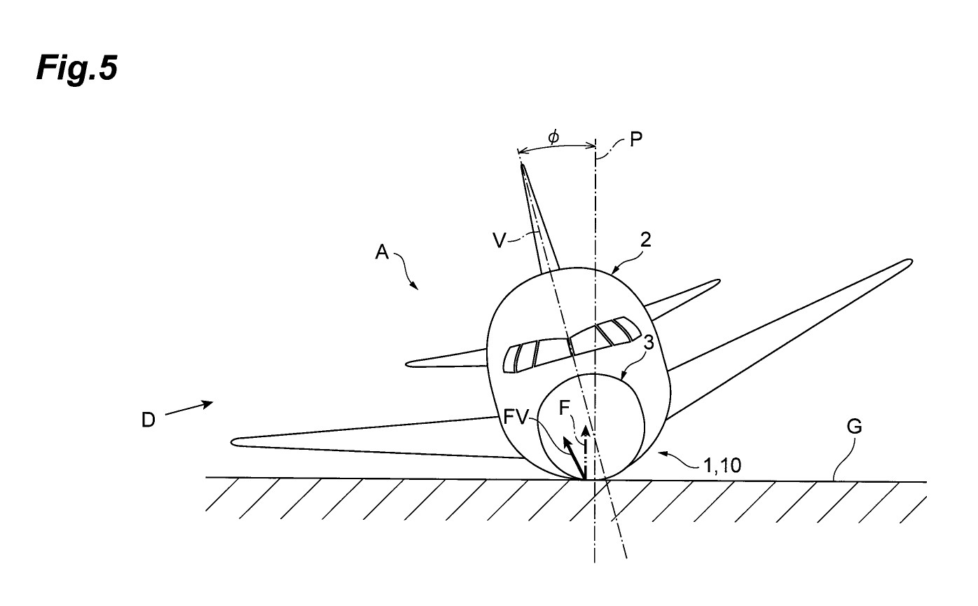

In a case where the airframe A has touched down at a small rolling angle φ as shown in FIG. 5, members (for example, the first lateral member 12 or the bottom member 11 shown in FIG. 2) near the bottom among the members which constitute the position adjusting unit 10 face the ground G side. Then, the position adjusting unit 10 receives the ground reaction force F from the ground G via the first lateral member 12 or the bottom lateral member 11.

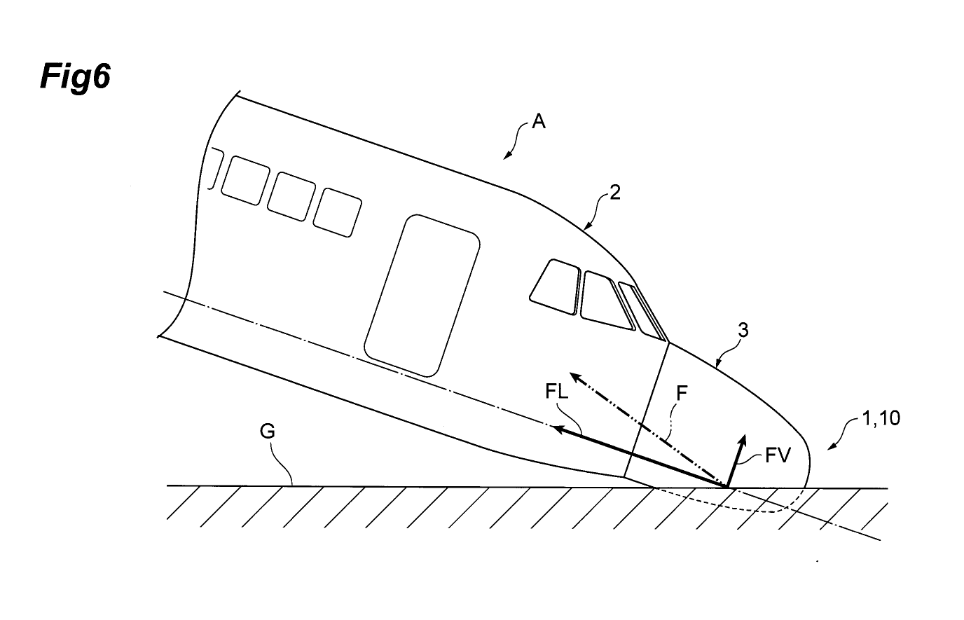

Since the first lateral member 12 or the bottom member 11 has a lower strength than the second lateral member 13 or the third lateral member 14, wear, compressive deformation, destruction, or the like occur when the ground reaction force F is received. As the bottom member 11 receives the ground reaction force F and deformation or the like thereof occurs, the ground reaction force F is absorbed and reduced. As a result, as shown in FIGS. 5 and 6, the component force FV in the up-and-down direction of the airframe also becomes relatively small.

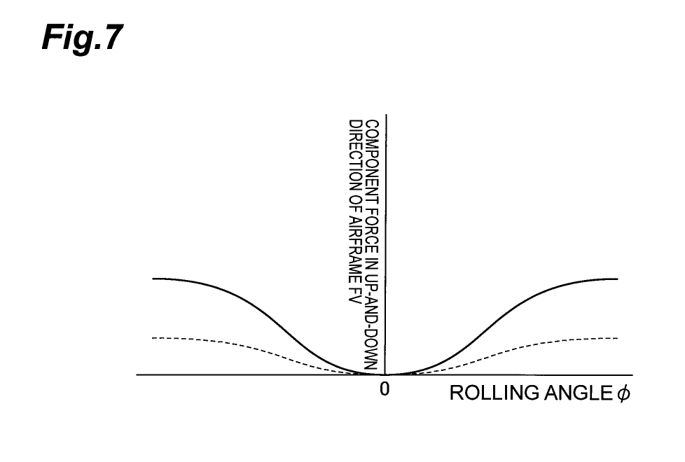

FIG. 7 shows the relationship between the rolling angle φ and the component force FV in the up-and-down direction of the airframe, when the airframe touches down. As shown in FIG. 7, according to the magnitude of the rolling angle φ, the component force FV, in the up-and-down direction of the airframe, of the ground reaction force F that the airframe A receives changes. That is, the position adjusting unit 10 is configured such that, as the rolling angle φ when the airframe A touches down becomes greater, the component force FV, in the up-and-down direction of the airframe, of the ground reaction force F becomes greater. A self-alignment action which adjusts the position of the airframe A in the horizontal direction is exerted by such a component force FV in the up-and-down direction of the airframe. In addition, in FIG. 7, a solid line (upper curve) shows a case where the speed when the airframe touches down is high, and a broken line (lower curve) shows a case where the speed when the airframe touches down is low.

Additionally, when the position of the airframe A is adjusted so as to become horizontal, the EA structure (not shown) which is provided at the bottom of the fuselage touches down, and impact energy is absorbed while receiving a dynamic frictional force from the ground so that the airframe A can be safely stopped. That is, according to the position adjusting unit 10, the position of the airframe A inclined in the left-and-right direction is adjusted, so that the EA structure of the bottom of the airframe A can be made to function effectively.

As described above, in the airframe position adjusting structure 1 related to the present embodiment, the position adjusting unit 10 is configured such that, as the rolling angle φ when the airframe A touches down becomes greater, the component force FV, in the up-and-down direction of the airframe, of the ground reaction force F received from the ground G becomes greater.

Therefore, in the airframe position adjusting structure 1, as the inclination of the airframe A in the left-and-right direction becomes greater, the component force FV, in the up-and-down direction of the airframe, of the ground reaction force F that the position adjusting unit 10 receives from the ground G becomes greater. The component force FV, in the up-and-down direction of the airframe, of this ground reaction force F acts as a force to return the airframe A horizontally. Accordingly, according to the airframe position adjusting structure 1, when the airframe A touches down, the position of the airframe A inclined in the left-and-right direction can be adjusted.

Additionally, it is considered that, as the rolling angle φ becomes greater when the airframe A touches down, the portion where the nose 3 which constitutes the tip portion of the fuselage 2 of the airframe A touches the ground G becomes a portion which is separated from the bottom. In the airframe position adjusting structure 1, the strength of the position adjusting unit 10 is made greater as the distance from the bottom of the nose 3 becomes greater.

Since the position adjusting unit 10 is less easily deformed as the strength of the touchdown portion is greater in this way, the ground reaction force F that the position adjusting unit 10 receives from the ground G is not absorbed, and a large ground reaction force F is generated. Hence, according to the airframe position adjusting structure 1 related to the present embodiment, as the rolling angle φ when the airframe A touches down becomes greater, the action of a force to return the airframe A horizontally becomes greater, so that the position of the airframe A can be effectively adjusted.

Additionally, according to the airframe position adjusting structure 1, the position adjusting unit 10 is composed of members with greater strength as the distance from the bottom of the nose 3 becomes greater. Therefore, a greater strength can be given as the distance from the bottom becomes greater. Hence, the airframe position adjusting function is favorably realized.

Moreover, according to the airframe position adjusting structure 1, the position of the airframe A is adjusted using the ground reaction force F when the airframe touches down. Therefore, a large operating force can be obtained simultaneously with touchdown, without using power separately. Additionally, since the horizontal position of the airframe A rotates so as to become a stable point according to the position to which the ground reaction force F is applied and the magnitude of the ground reaction force, a highly reliable mechanism is obtained without requiring a special position adjustment control. Additionally, even in a state where the speed of the airframe A is high, a position adjusting function is exhibited by using a ground reaction force F which increases as the speed becomes greater.

### Second Embodiment

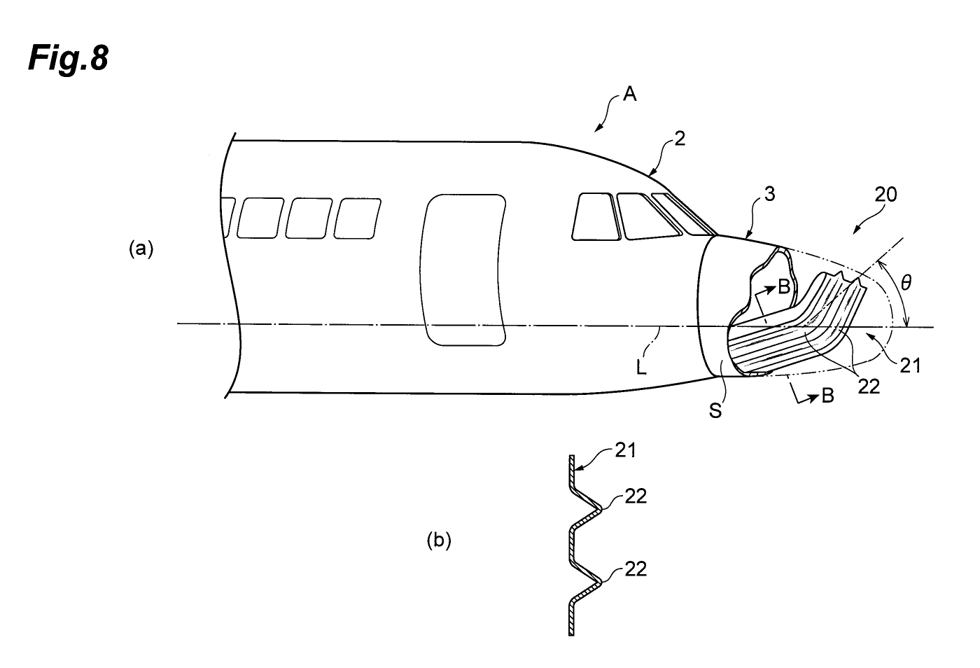

FIG. 8 is a partial fragmentary side view of an airframe position adjusting structure related to a second embodiment. A position adjusting unit 21 of an airframe position adjusting structure 20 shown in FIG. 8 is different from the position adjusting unit 10 related to the first embodiment shown in FIG. 1 in that this position adjusting unit has a protruding portion 22 which protrudes toward the surface side of the nose 3, instead of the plurality of members 11 to 14.

As shown in FIG. 8A, the protruding portion 22 is provided so as to extend toward the lateral side from the bottom of the nose 3. Additionally, as shown in a cross-sectional view taken along the line B-B of FIG. 8B, a plurality of the protruding portions 22 is arranged in parallel at predetermined intervals. Moreover, the protruding portions 22 extend in a direction in which the angle θ formed with respect to the front-and-back direction line L of the nose 3 becomes greater as the distance from the bottom of the nose 3 becomes greater.

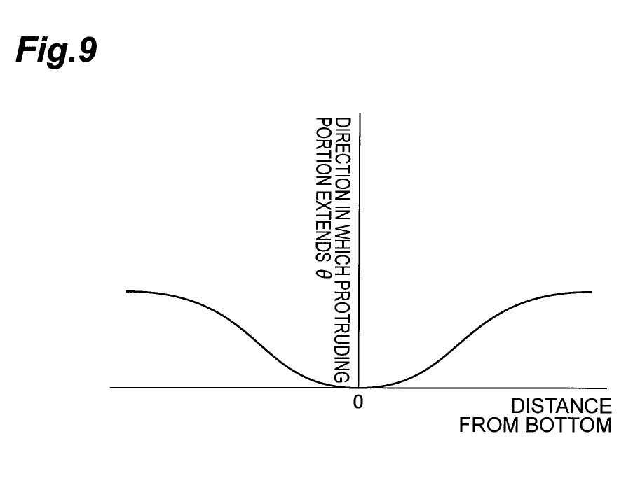

The relationship between the distance from the bottom of the nose 3 in the airframe position adjusting structure 20, and the direction in which the protruding portion 22 extends is shown in FIG. 9. Here, the “distance” of the horizontal axis is not a straight-line distance between the lowermost part of the nose 3 and each point on the protruding portions 22, but a distance along the peripheral surface of the nose 3.

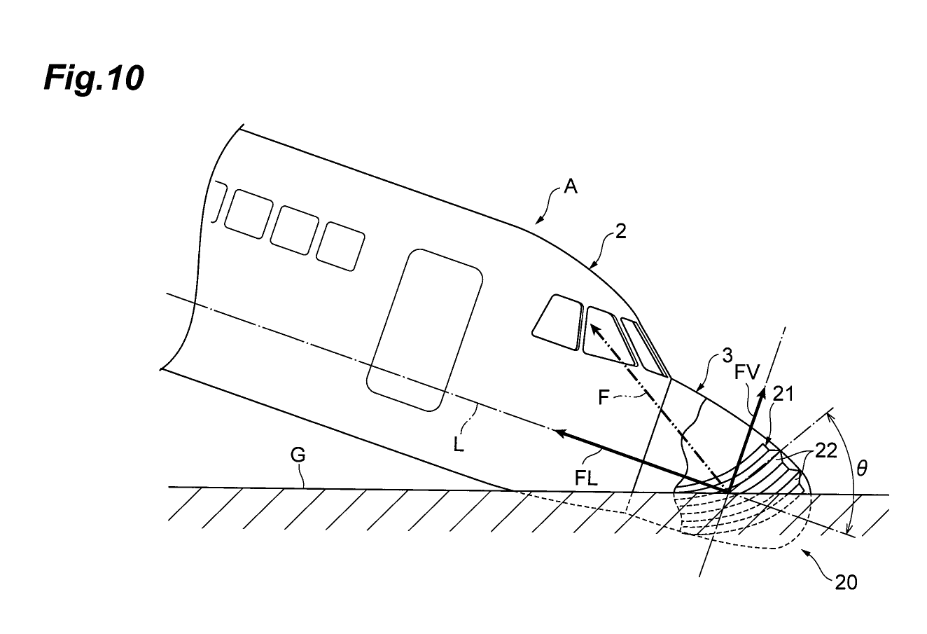

According to such an airframe position adjusting structure 20, in a case where the airframe A has touched down at a large rolling angle φ as shown in FIG. 3, as shown in FIG. 10, the ground reaction force F from the ground G is applied to the portions of the protruding portions 22 near the lateral side, that is, portions extending in a direction in which the angle θ formed with respect to the front-and-back direction line L of the nose 3 is large. Then, as the protruding portions 22 act as resistance, the component force FV, in the up-and-down direction of the airframe, of the ground reaction force F becomes large. Hence, as the rolling angle φ when the airframe A touches down becomes greater, the action of a force to return the airframe A horizontally become greater, so that the position of the airframe A can be effectively adjusted.

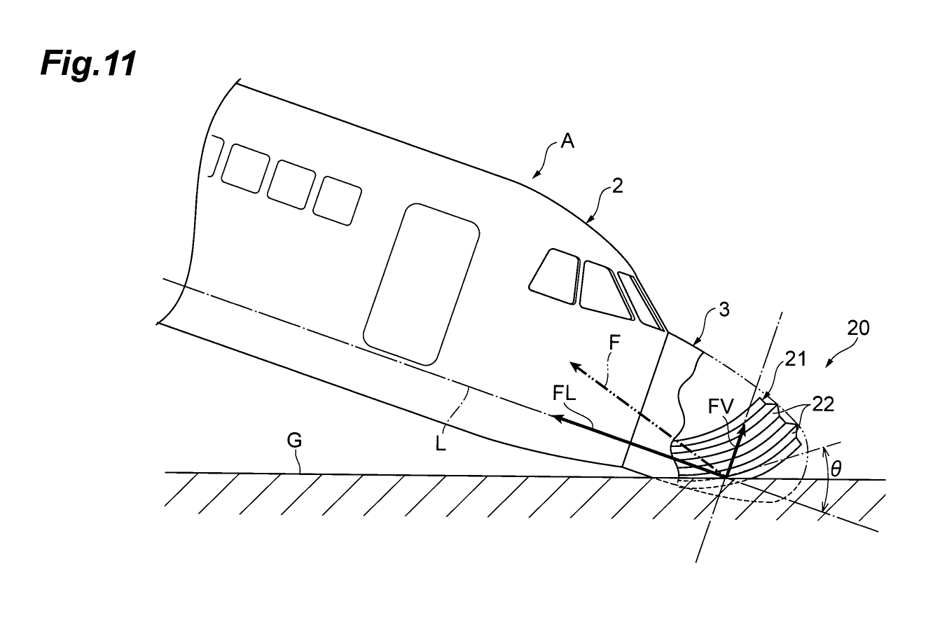

Additionally, in a case where the airframe A has touched down at a small rolling angle φ as shown in FIG. 5, as shown in FIG. 11, the ground reaction force F is applied to the portions of the protruding portions 22 near the bottom, that is, portions extending in a direction in which the angle θ formed with respect to the front-and-back direction line L of the nose 3 is small. Then, the protruding portions 22 do not act as strong resistance, but the ground reaction force F becomes small compared to the case of FIG. 10. As a result, the component force FV in the up-and-down direction of the airframe also becomes relatively small.

In this way, even in the airframe position adjusting structure 20, the relationship between the rolling angle φ and the component force FV in the up-and-down direction of the airframe becomes the same as the relationship shown in FIG. 7. Therefore, a self-alignment action which adjusts the position of the airframe A in the horizontal direction is exerted by the component force FV in the up-and-down direction of the airframe, so that the EA structure of the bottom of the airframe can be made to function effectively.

Additionally, in the airframe position adjusting structure 20, the protruding portions 22 extend while the angle θ is changed. Therefore, in a case where the rolling angle φ is large, a resistance force caused by the protruding portions 22 becomes large. However, the position of the airframe is naturally adjusted in a direction in which the resistance force becomes small, that is, in the horizontal direction in which the rolling angle φ becomes small.

### Third Embodiment

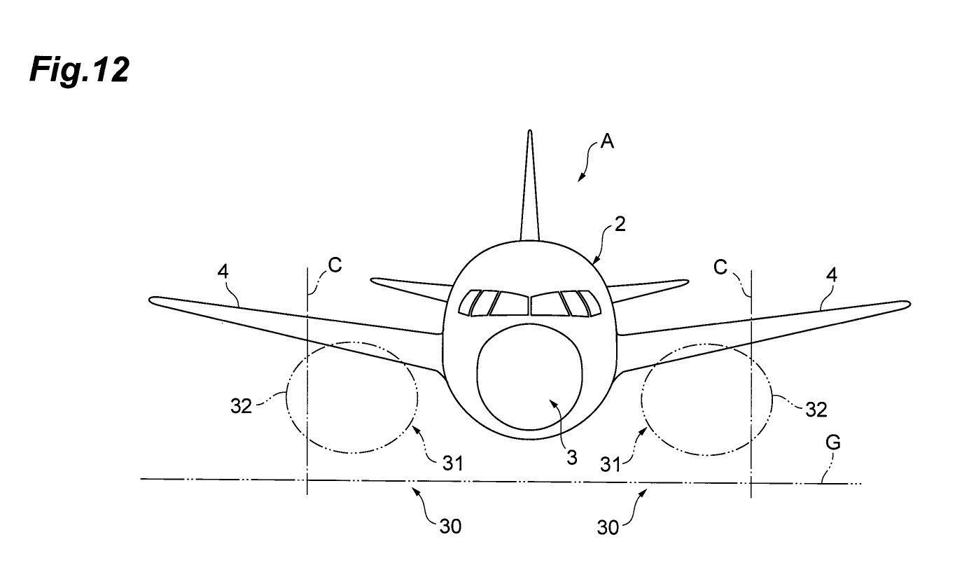

FIG. 12 is a front view of an airframe position adjusting structure related to a third embodiment. A position adjusting unit 31 of an airframe position adjusting structure 30 shown in FIG. 12 is different from the position adjusting units 10 and 21 related to the earlier embodiments shown in FIGS. 1 and 8 in that this position adjusting unit has an air bag 32 on the undersurface of each of the right and left main wings 4 of the airframe A. In addition, in the airframe position adjusting structure 30, the position adjusting unit is not provided at the nose 3.

As shown by an imaginary line in FIG. 12, the air bags 32 can be deployed when the airframe A touches down. Additionally, the air bags 32 are provided nearer the fuselage 2 than central portions C of the main wings 4 in the longitudinal direction. More specifically, the air bags 32 are attached to spars (not shown) which are frame members of the main wings 4, at spots nearer the fuselage 2 than the central portions C of the main wings 4 in the longitudinal direction.

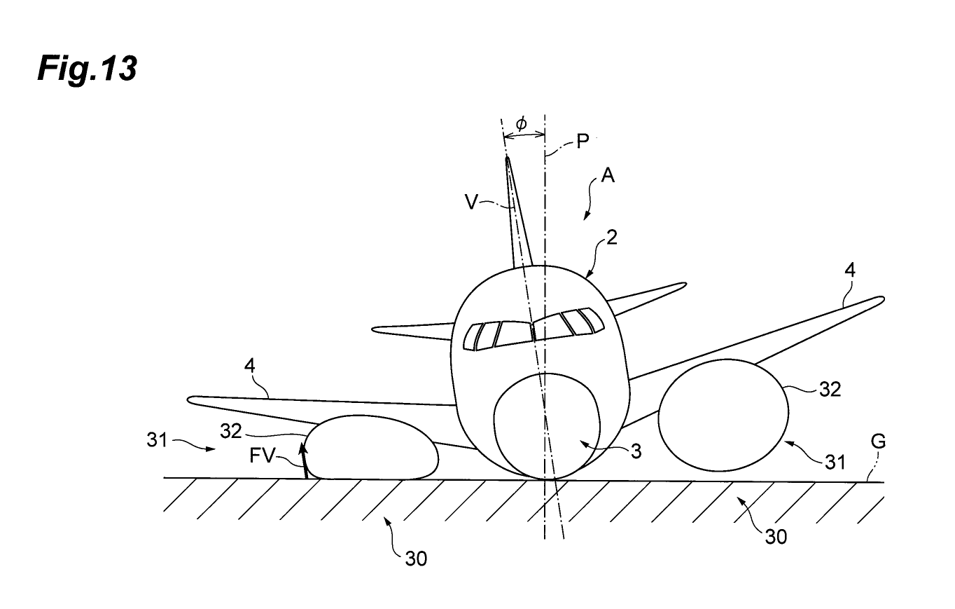

According to such an airframe position adjusting structure 30, as shown in FIG. 13, when the airframe A touches down, the air bags 32 that the position adjusting unit 31 have on the undersurfaces of the main wings 4 is deployed. Since the pushing of air bags 32 against the ground G becomes stronger as the rolling angle φ of the airframe A becomes greater, the component force FV, in the up-and-down direction of the airframe, of the ground reaction force F that the position adjusting unit 31 receives from the ground G becomes greater by that amount. Hence, the position of the airframe A can be adjusted while mitigating the impact to the airframe A.

Additionally, according to the airframe position adjusting structure 30, the air bags 32 are provided nearer the fuselage 2 than the central portions C of the main wings 4 in the longitudinal direction. Therefore, even in a case where the main wings 4 of the airframe A ground and the tips thereof drop out, the air bags 32 remain on the fuselage 2 side, without dropping out. Hence, the airframe position adjusting function is favorably realized.

In this way, even in the airframe position adjusting structure 30, a self-alignment action which adjusts the position of the airframe A in the horizontal direction is exerted, so that the EA structure of the bottom of the airframe can be made to function effectively. Additionally, since the air bags 32 are provided at both the right and left main wings 4, even in a case where the ground reaction force F acts on one air bag 32, and the airframe A is inclined to the opposite side, suitable position adjustment is made as the other air bag 32 functions. Moreover, the impact applied to the crew or the like of an aircraft is mitigated by a impact-absorbing action of the air bags 32.

Conventionally, since the adjustment of the rolling angle has the center of gravity on a moment-of-inertia axis unlike the adjustment of the so-called pitch angle at which the nose is inclined up and down on the basis of the lateral axis of the airframe, the mobility of the adjustment is poor, and it is difficult to obtain a rotative force for adjustment of position. According to the airframe position adjusting structure 30, since the rotative force is obtained by the air bags 32, adjustment of the rolling angle with high responsiveness can be performed.

Although the preferred embodiments of the invention have been described above, the airframe position adjusting structure related to the invention is not limited to the above embodiments. Although the case where the position adjusting unit 10 is formed from four kinds of members 11 to 14 of different materials has been shown in the above first embodiment, the position adjusting unit may be formed from, for example, two kinds or three kinds of members. Additionally, the position adjusting unit 10 is not limited to the structure in which strength is changed in a stepwise fashion using the plurality of members, but may be a structure in which strength is continuously changed by changing thickness, density, or the like.

Additionally, although the case where the position adjusting unit is provided at the nose 3 has been described in the first and second embodiments above, the position adjusting unit may be provided from the bottom of the fuselage 2 to the lateral side behind the nose 3. According to this, the position of the airframe A inclined in the left-and-right direction can be adjusted not only in a case where the airframe A is inclined forward and touches down from the nose 3, but also in a case where the airframe touches down from the central portion and rear portion of the fuselage 2 without being inclined forward.

### INDUSTRIAL APPLICABILITY

According to the invention, an airframe position adjusting structure in which the position of the airframe inclined in the left-and-right direction can be adjusted can be provided.

1. An airframe position adjusting structure comprising a position adjusting unit which adjusts the position of an airframe using a ground reaction force that the airframe receives when the airframe touches down,
wherein the position adjusting unit is configured such that, as the rolling angle when the airframe touches down becomes greater, a component force in the up-and-down direction of the airframe, of the ground reaction force becomes greater.

2. The airframe position adjusting structure according to claim 1,
wherein the position adjusting unit is provided within a predetermined range from the bottom of a fuselage of the airframe to the lateral side, and the strength of the position adjusting unit is made greater as the distance from the bottom becomes greater.

3. The airframe position adjusting structure according to claim 2,
wherein the position adjusting unit is composed of members with greater strength as the distance from the bottom becomes greater.

4. The airframe position adjusting structure according to claim 1,
wherein the position adjusting unit has protruding portions which protrude toward the surface side of the fuselage of the airframe and extend toward the lateral side from the bottom of the fuselage, and
wherein the protruding portions extend in a direction in which the angle formed with respect to a front-and-back direction line of the fuselage becomes greater as the distance from the bottom becomes greater.

5. The airframe position adjusting structure according to claim 1,
wherein the position adjusting unit has air bags capable of being deployed when the airframe touches down, on the undersurfaces of right and left main wings of the airframe.

6. The airframe position adjusting structure according to claim 5,
wherein the air bags are provided nearer the fuselage than the central portions of the main wings in the longitudinal direction.
